(19) United States
(12) Patent Application Publication
(10) Pub. No.: US 2004/0258613 A1
(43) Pub. Date: Dec. 23, 2004

(54) Process for the production and purification of sodium hydride

(76) Inventors: Jorg Heller, Engelskirchen (DE); Hans-Peter Gerlach, Herschbach (DE); Hans De Vries, Ng Heerde (NL)

Correspondence Address: SUTHERLAND ASBILL & BRENNAN LLP, 999 PEACHTREE STREET, N.E., ATLANTA, GA, 30309, US

(21) Appl. No.: 10/485,329

(22) PCT Filed: Jul. 26, 2002
(86) PCT No.: PCT/EP02/08333

(30) Foreign Application Priority Data
Jul. 28, 2001 (EP) 011182102

(51) Int. Cl. C01B 6/04

(52) U.S. Cl. 423/646

(57) ABSTRACT

The present invention relates to a process for the production of sodium hydride, wherein a carbonaceous compound is incorporated in a melt which includes sodium hydroxide or a mixture of one or more alkali metal hydroxides in the absence of oxygen and moisture and is heated at a temperature above the decomposition temperature of sodium hydride of 420° C., and the reaction product is subsequently separated at temperatures of ≦420° C. outside the reaction medium.

The invention also relates to a process for the purification of impure sodium hydride, wherein the sodium hydride, in the absence of oxygen and moisture, is incorporated in a melt, which melt is heated at temperatures above the decomposition temperature of sodium hydride of 420° C. and includes one or more alkali metal hydroxides, and subsequently deposited at temperatures of ≦420° C. outside the melt medium.

The present invention relates to a process for the production of high-purity, fine-grain sodium hydride and to a process for the purification of impure sodium hydride.

Sodium hydride is a salt which, in pure form, forms colorless crystals and, due to sodium impurities, is commercially available only as a gray substance. It is extremely sensitive to moisture and ignites in dry air at 230° C. to form sodium oxide. Slow liberation of hydrogen at temperatures above 300° C. is followed by rapid decomposition into the elements from 420° C. on, without previous melting.

Owing to its basicity, sodium hydride is frequently used in the organic synthetic chemistry to generate carbanions or in deprotonation, because it undergoes rapid reaction even under mild conditions without formation of byproducts apart from hydrogen.

Complexed with alcoholates and metallic salts, as well as at high temperatures in molten sodium hydroxide, sodium hydride is also a powerful reducing agent predominantly used in the production of finely powdered metals and in the surface treatment thereof.

Another important field of use is the production of mixed metal hydrides, such as NaBH₄ or NaAlH₄, which also find use in organic synthesis. In particular, NaAlH₄ was found to have outstanding features in promising new areas, e.g. in the field of hydrogen storage (see Bogdanovic et al., Appl. Phys. A 72, 221-223 (2001)).

Due to the low solubility of sodium hydride in inert organic solvents, caused by its salt-like character, the particle size and the magnitude of the surface area are crucial to its use both in organic syntheses and, in particular, in the production of mixed metal hydrides, and additional activation being required in the most unfavorable case of large particles with correspondingly small surface area.

To date, the production of sodium hydride is effected either by passing hydrogen over molten sodium at 250-300° C., preferably in mineral oil, or by hydrogenation of sodium oxide with hydrogen, with simultaneous formation of sodium hydroxide. The sodium hydride thus obtained comes on the market dispersed in mineral oil or formed into slabs with NaOH and has a gray color as a result of sodium metal impurities (Römpp, Chemie-Lexikon, Vol. 4, 1995, p. 2928).

The above-mentioned production processes not only involve the drawback of being relatively cost-intensive, but also, they necessitate additional—sometimes very costly—activation, purification and/or pulverizing of the sodium hydride for many types of use. Moreover, the handling of sodium hydride has its problems due to the high reactivity thereof, which is why its use is often restricted to the laboratory scale.

DE 33 13 889 C2 describes a process and a device for the disposal of toxic and special waste. For disposal of biological residues, especially cellulose and glucose, said residues are heated to their decomposition temperature together with sodium hydroxide in an induction oven to form sodium hydride and CO. Under the conditions present therein, however, the sodium hydride having formed remains as a solid dissolved in the sodium hydroxide melt and therefore is obtained in analogy to the previous production processes.

Especially with respect to the interesting new fields of use, such as the hydrogen storage mentioned above, the present invention is therefore based on the object of providing a process for the production of sodium hydride, which process is favorable in cost, with a minimum of equipment required, and affords sodium hydride in a pure, finely distributed form.

Surprisingly, it has been found that the above object can be accomplished according to the invention by incorporation of carbonaceous compounds in a melt including sodium hydroxide or mixtures of sodium hydroxide and one or more other alkali metal hydroxides, which melt is heated to a temperature above the decomposition temperature of sodium hydride of 420° C. in the absence of oxygen and moisture, and subsequent separation of the reaction product outside the reaction medium by cooling to temperatures of ≦420° C.

The resulting sodium hydride initially dissolves in the melt, but then undergoes decomposition into sodium and hydrogen as a result of the temperatures present therein. Presumably, gaseous hydrogen present in the reaction forming the sodium hydride and formed during decomposition thereof entrains sodium when escaping from the melt, which sodium undergoes recombination elsewhere outside the reaction medium as a result of cooling, thus forming high-purity sodium hydride in the form of a white powder having a grain size of <20 μm.

According to the prior art, sodium hydride is known to decompose rapidly above 420° C., but surprisingly, it has been observed that hydrogen and sodium in the process according to the invention undergo recombination to form high-purity fine-grain sodium hydride upon cooling to temperatures of ≦420° C., preferably from 150 to 300° C.

As carbonaceous compounds, which can be in solid, as well as in liquid or gaseous form, it is preferred to use industrial waste materials such as polyethylene, polypropylene, polyesters, waste oil, waste rubber, bitumens, tars, oil sludges, and cellulose, or mixtures thereof.

Thus, the present process offers the advantage of converting low-cost industrial waste materials, which otherwise had to be put to costly disposal, into materials allowing industrial utilization.

In a particularly preferred fashion, the melt including sodium hydroxide is heated at temperatures of from 650 to 900° C. Maximum yields are obtained when the temperature of the melt is close to the boiling temperature of sodium (881° C.), because in this event, the sodium is no longer required to be entrained with hydrogen escaping from the melt but is capable of escaping from the melt by itself in the form of gas.

In a particularly preferred procedure, hydrogen is introduced into the sodium hydroxide melt. Firstly, this is advantageous in that continuous purging with hydrogen is effected, so that an atmosphere free of oxygen and moisture can be provided. Secondly, efficient stripping of liquid sodium at temperatures of the melt below the boiling temperature of sodium is effected. In addition, the hydrogen atmosphere facilitates recombination of sodium and hydrogen to form sodium hydride. When using inert gases instead of hydrogen, recombination to form sodium hydride, while possible in principle, should be more difficult because the collision rate, i.e., the number of effective collisions between two particles resulting in a reaction, depends on the particle density of a particular particle in a corresponding volume, among other things. Regarding hydrogen in a hydrogen atmosphere, said number obviously is substantially higher compared to an inert gas atmosphere wherein only a certain percentage of hydrogen is present.

To isolate the individual products formed in the reaction, it is advantageous to withdraw the mixture of hydrogen and gaseous or entrained liquid sodium from the reaction space.

This permits not only specific deposition of sodium hydride recombining upon cooling, but also, in order to obtain sodium hydride with highest possible purity, separation of possibly entrained sodium carbonate—which also forms as a product and can be entrained with the stream of gas—prior to sodium hydride deposition, using a cyclone separator, for example.

The sodium hydride produced in this way is obtained as a white, highly pure, extremely fine powder having a grain size of <20 μm and has high reactivity without additional activation.

The hydrogen being formed is free of impurities and can be put to further use as required.

The distinctive feature of the process described above, i.e., utilizing the dissociation of sodium hydride during heating and its recombination upon cooling under the conditions according to the invention, which has been noted for the first time, is also applicable to the purification of commercially available, impure sodium hydride.

To this end, the impure sodium hydride—instead of the carbonaceous compound—is directly incorporated in the melt in the absence of oxygen and moisture, which melt is heated at temperatures above the decomposition temperature of sodium hydride of 420° C. and includes an alkali metal hydroxide or a mixture of alkali metal hydroxides, and subsequently deposited outside the melt medium at temperatures of ≦420° C., preferably from 150 to 300° C.

As sodium hydride is already being used, the melt does not necessarily have to include sodium hydroxide in the above case.

In this case as well, the incorporated sodium hydride is dissolved in the melt and subsequently undergoes decomposition as a result of the temperatures present therein. Presumably, the gaseous hydrogen thus formed escapes from the melt, thereby entraining the sodium. When cooling this reaction mixture outside the melt medium, recombination takes place and thus, deposition of solid, finely powdered, high-purity sodium hydride.

The temperature of the melt is preferably between 650 and 900° C. In the purification of impure sodium hydride, a significant increase of the yield is observed the closer the temperature of the melt approaches the boiling temperature of sodium or exceeds said temperature. One explanation would be that the hydrogen entraining the sodium from the melt solely originates from the decomposition of the impure sodium hydride and is therefore barely capable of entraining the sodium in full extent.

It is for this reason that a preferred process involves continuous passage of hydrogen through the alkali metal hydroxide melt. This is advantageous not only with respect to the entrainment of sodium from the melt, but also, in particular, with regard to elevating the degree of recombination by increasing the hydrogen density in the gas volume.

Advantageously, the hydrogen gas including the sodium is withdrawn, so that deposition of the sodium hydride caused by cooling specifically takes place outside the reaction space, thereby allowing separation of the sodium hydride from the other reaction products.

A plant for performing the process of the invention is exemplified below, but possible embodiments should not be confined to this plant.

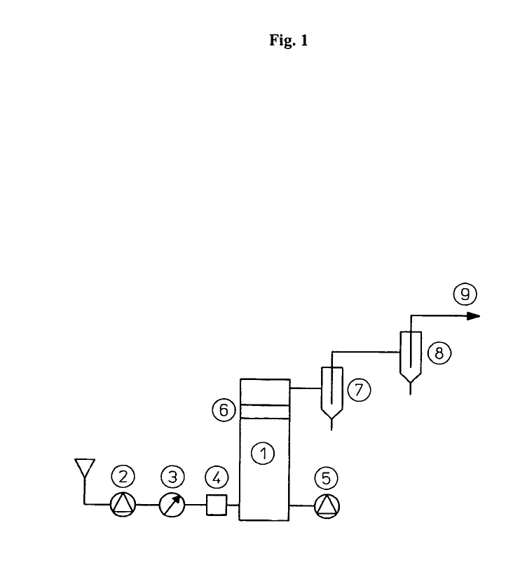

FIG. 1 shows a schematic illustration of a plant for the production of sodium hydride according to the process described above, wherein:

1 Reactor

2 Material supply

3 Measuring instrument

4 Cooling means

5 Hydrogen supply

6 Internal carbonate separation

7 External carbonate separation

8 Sodium hydride separation

9 Hydrogen outlet

The reaction of formation of sodium hydride takes place in a heatable reactor 1 which, in order to avoid loss of hydrogen due to the high diffusion rate thereof, preferably consists of low-carbon steel and contains at least sodium hydroxide or a mixture of sodium hydroxide and one or more other alkali metal hydroxides. To maintain an atmosphere free of oxygen and moisture, the plant preferably is purged completely with hydrogen prior to introducing the sodium hydroxide. For example, but not necessarily, the reactor is heated by electrical means, so that temperatures between 650 and 900° C, are present in the sodium hydroxide melt being formed. A well-defined amount of a solid, liquid or gaseous carbonaceous compound or mixture thereof is introduced into the melt via a metering device 2, using a measuring instrument 3 such as a flow meter.

To avoid premature reactions in the metering device as a result of the high temperatures in the reactor, which reactions might give rise to inlet blocking, there is the option of cooling this region with cooling means 4.

Following introduction of the carbonaceous compound, the following reaction proceeds in the melt:

“C”+3NaOH→Na₂CO₃+NaH+H₂

“C” represents carbon of a carbonaceous compound in general.

Advantageously, the heat of reaction liberated during the above reaction allows maintaining the temperature of the melt over a prolonged period of time without additional heating.

In a particularly preferred embodiment, hydrogen is continuously fed into the melt by means of compressor pump 5. The compressor pump 5 is preferably arranged separated from the material supply 2. As set forth above, this facilitates both stripping of liquid or gaseous sodium from the melt and recombination to form sodium hydride.

To prevent the sodium carbonate formed in the reaction from being entrained out of the melt by the stream of gas and from causing impurities during sodium hydride separation, the reactor preferably includes a first internal means 6, e.g. in the form of a demister, to retain the sodium carbonate.

Thereafter, the stream of gas, together with the sodium and the sodium carbonate possibly entrained in part despite the demister, passes out of the reactor and into an optionally heatable external carbonate separation means 7 arranged downstream of the reactor, wherein the sodium carbonate is separated. The separating means can be a cyclone separator, for example.

This is followed by a means 8 for sodium hydride separation, which also may consist of a cyclone separator provided with a cooling means. Cooling effects recombination of sodium and hydrogen to form sodium hydride which, converted into the solid phase, is deposited as a highly pure, white, fine-grain powder and can be removed.

The remaining hydrogen is likewise free of impurities and can be re-fed into the melt either completely or partially, or can be put to further use via hydrogen outlet 9.

The following Table 1 exemplifies the results of reactions with miscellaneous materials used in the production of sodium hydride in a plant as described above, without limiting the invention thereto.

### EXAMPLES

General Procedure

The feed materials listed in Table 1 are introduced into a NaOH melt heated at temperatures of from 670 to 875° C. (see Examples 1 to 8 in Table 1) and situated in a reactor consisting of low-carbon steel, which has been purged with hydrogen prior to supplying the NaOH. A stream of hydrogen is passed into the melt and withdrawn together with gaseous reaction products. The reactor includes a demister retaining the sodium carbonate in the melt, which is formed as a reaction product. The hydrogen being formed, together with sodium as decomposition product of sodium hydride, is first passed out of the reactor together with the introduced stream of hydrogen and into a cyclone separator heated at a temperature of from 420 to 530° C., and unintentionally entrained sodium carbonate is separated. The remaining stream of gas is passed through a second cyclone separator wherein recombination of the sodium hydride and separation thereof proceeds at a temperature of from 150 to 300° C. Part of the remaining hydrogen is re-fed into the melt, the other part is collected for further use.

TABLE 1
Reactions of miscellaneous materials used in the production of NaH

| | | | Temperature | Weight | | |
|---|---|---|---|---|---|---|
| Exam- | | | of melt | of melt | Yield NaH | |
| ple | Feed material | Throughput | [° C.] | [kg] | [g] | [% of theory] |
| 1 | Propane gas | 150 l | 670 | 6.8 | 459 | 95 |
| 2 | Propane gas | 147 l | 776 | 6.8 | 451 | 96 |
| 3 | Propane gas | 284 l | 872 | 6.8 | 871 | 96 |
| 4 | Paraffin oil | 0.42 l | 873 | 6.8 | 528 | >99 |
| 5 | Rubber (isoprene) | 88.3 g | 873 | 6.8 | 155 | >99 |
| 6 | Waste rubber | 529 g | 873 | 6.8 | 886 | 95 |
| 7 | Waste rubber/ | 567 g | 872 | 6.8 | 925 | 95 |
| | waste oil (1:1 w/w) | | | | | |
| 8 | Carbon | 78.3 g | 871 | 6.8 | 155 | >99 |

The respective reactions are based on the following reaction equations:

Propane gas: C₃H₈+9 NaOH→3 NaH+7H₂+3 Na₂CO₃

Paraffin oil: C₁₂H₂₆+36 NaOH→12 NaH+12 Na₂CO₃+25 H₂

Isoprene: C₅H₈+15 NaOH→5 NaH+5 Na₂CO₃+9 H₂

Carbon: C+3 NaOH→NaH+Na₂CO₃+H₂

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A process for the production of sodium hydride in the form of a white powder having a grain size of <20 μm, comprising incorporating a carbonaceous compound, in the absence of oxygen and moisture, in a melt which comprises sodium hydroxide or a mixture of sodium hydroxide and one or more alkali metal hydroxides which is heated at a temperature above the decomposition temperature of sodium hydride of 420° C., and separating the reaction product at temperatures of ≦420° C. outside the reaction medium, and wherein a stream of hydrogen is introduced into the sodium hydroxide melt.

13. The process according to claim 12, wherein industrial waste materials or mixtures thereof are used as carbonaceous compounds which can be in solid, as well as in liquid or gaseous form.

14. The process according to claim 12, wherein the melt is heated at temperatures between 650 and 900° C.

15. The process according to claim 12, wherein the sodium hydride being formed is withdrawn in the form of decomposition products, together with the hydrogen gas formed and/or introduced, and, following subsequent recombination, is re-deposited by cooling.

16. Sodium hydride having a grain size of <20 μm, which can be obtained using the process according to claims 12-15.

17. A process for the purification of impure sodium hydride, comprising incorporating sodium hydride, in the absence of oxygen and moisture, in a melt which is heated at temperatures above the decomposition temperature of sodium hydride of 420° C. and comprises an alkali metal hydroxide or a mixture of alkali metal hydroxides, and depositing pure sodium hydroxide at temperatures of ≦420° C. outside the melt medium, and in which process a continuous stream of hydrogen is introduced into the alkali metal hydroxide melt.

18. The process according to claim 17, wherein the melt is heated at temperatures between 650 and 900° C.

19. The process according to claim 17 or 18, wherein the sodium hydride is withdrawn in the form of decomposition products, optionally together with the introduced hydrogen gas, and, following subsequent recombination, is re-deposited by cooling.
